(19) United States
(12) Patent Application Publication
(10) Pub. No.: US 2014/0164224 A1
(43) Pub. Date: Jun. 12, 2014

(54) TARGETING BANKING CENTER CUSTOMERS FOR CHANNEL MIGRATION WITH BANKING CENTER REPRESENTATIVE-PERSONALIZED ALERTS

(71) Applicant: BANK OF AMERICA CORPORATION, Charlotte, NC (US)

(72) Inventors: David M. Grigg, Rock Hill, NC (US); Matthew A. Calman, Charlotte, NC (US); Glenn Grossman, Matthews, NC (US); Carrie Anne Hanson, Charlotte, NC (US)

(73) Assignee: Bank of America Corporation, Charlotte, NC (US)

(21) Appl. No.: 13/712,520

(22) Filed: Dec. 12, 2012

(51) Int. Cl. G06Q 20/22

(52) U.S. Cl. CPC G06Q 20/22
USPC 705/39

(57) ABSTRACT

Embodiments of the invention relate to systems, methods, and computer program products for targeting financial institution channel migration away from first channel, such as banking centers and towards other transaction channels using banking representative-personalized recommendation alerts. In this regard the present invention serves to inform and encourage financial institution customers to use other more optimal financial institution channels for conducting transactions. Once recommendations for alternative transaction channels have been determined, alerts are generated and communicated within a selected time frame after the banking center transaction has been conducted. In addition to the recommendations, the alert is personalized by the banking center representative that assisted the customer, so as to further gain the attention of the customer. Moreover, the alerts may include further information to encourage the customer to use the recommendations, such as directions to the alternative financial institution channels, instructions for using the alternative channels and the like.

### FIELD

In general, embodiments of the invention relate to methods, systems, apparatus and computer program products for marketing financial institution channels and, more particularly, targeting transaction migration from financial representative-based channels to other financial institution channels with banking representative-personalized alerts.

### BACKGROUND

Financial institution customers, otherwise referred to as banking customers, tend to be creatures of habit in terms of how they conduct their banking transactions. For example, if a customer goes to a physical location, such as an Automated Teller Machine (ATM) or banking center or the like, to conduct a transaction, such as a withdrawal or a deposit, chances are that the customer regularly on an on-going basis goes to that ATM or banking center to conduct the same or similar transactions.

However, the customer's chosen means for regularly and continuously conducting financial institution transactions may not be the most optimal means for conducting the financial institution transactions. For example, from the customer perspective optimization may be realized by a more convenient (i.e., time efficient), and thus typically a less costly, means for conducting the transaction. Other means for conducting the transaction provide for the customer to use another type of financial institution channel, e.g., banking center, ATM, direct deposit, online banking, mobile banking, person-to-person (P2P) payments or another location of the type of financial institution channel they are currently using. Specifically, if the customer typically drives to a banking center to conduct a transaction that could otherwise be performed at an ATM, or via online or mobile banking the customer would save time and money (e.g., fuel costs) if the customer were to change the financial institution channel at which the transaction occurs.

From the financial institution perspective optimization may also be realized by a more cost effective means for conducting the transaction. In this regard, transactions at the banking center, which involve a banking representative, tend to incur the most cost to the financial institution, while other financial institution channels such as ATMs, online or mobile banking may incur a lesser cost to the financial institution.

While in some instances, for example if the financial institution channel is relatively new to the industry, such as P2P payments or the like, the customer may be unaware of the option to perform the transaction via another channel. However, in many instances the customer is aware of the other financial institution channels but is reluctant to make a change. Such reluctance may be due to the customer not knowing how to perform the transaction at the other channel(s), not knowing the exact location of the other channel(s) or merely the customer being adverse to change.

Therefore, a need exists to develop systems, methods and the like which serve to inform and encourage financial institution banking center customers to use other more optimal financial institution channels for conducting transactions. In addition, the desired systems and methods should be able to provide the channel recommendations to the customer so as to overcome the reluctance to use the channels, for example, provide directions to the alternative channel and/or explicit instructions on how to use the channel. Moreover, the recommendation should be configurable to be communicated to the customer proximate in time to the customer conducting a transaction so that the customer more readily appreciates the benefits associated with the recommendations.

### SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention relate to systems, apparatus, methods, and computer program products for targeting financial institution channel migration and specifically targeting transaction migration away from financial institution representative-based channels to other more optimal financial institution channels. In this regard the present invention serves to inform and encourage financial institution customers to use other more optimal financial institution channels for conducting transactions. Once recommendations for alternative transaction channels have been determined, alerts are generated and communicated within a selected time after the banking center transaction has been conducted. In addition to the recommendations, the alert is personalized by the banking center representative that assisted the customer, so as to further gain the attention of the customer. Moreover, the alerts may include further information to encourage the customer to use the recommendations, such as directions to the alternative financial institution channels, instructions for using the alternative channels and the like.

An apparatus for targeting channel migration of financial institution transactions conducted by a customer of a financial institution defines first embodiments of the invention. The apparatus includes a computing platform including a memory and at least one processor. The apparatus further includes a targeting channel migration module stored in the memory and executable by the processor. The targeting channel migration module includes a channel migration recommendation sub-module configured to determine one or more second financial institution channels for a customer to conduct future financial institution transactions similar to a financial institution transaction conducted between the customer and a financial institution representative at a first financial institution channel. Additionally, the targeting channel migration module includes a channel migration alert sub-module configured to generate and communicate, within a selected time after conducting the financial institution transaction, a channel migration recommendation. The recommendation is personalized by the financial institution representative and recommends that the customer conduct future transactions, similar to the financial institution transaction, at the one or more second financial institution channels.

In specific embodiments of the apparatus, the targeting channel migration module further includes a transaction pattern recognition sub-module configured to determine that the customer continuously conducts transactions, similar to the financial transaction, at the first financial institution channel. In such embodiments of the apparatus, the channel migration alert sub-module is further configured to generate and communicate, within a selected time after conducting the financial institution transaction and determination of the transaction pattern, the channel migration recommendation.

In still further specific embodiments of the apparatus, the channel migration recommendation sub-module is further configured to determine the one or more second financial institution channels based on the one or more second financial institution channels being optimal to the financial institution based on a lowest financial institution cost per transaction. In related specific embodiments of the apparatus, the channel migration recommendation sub-module is further configured to determine the one or more second financial institution channels based on the one or more second financial institution channels being optimal to the customer based on a most time-efficient channel for conducting the transactions. While in further related embodiments of the apparatus, the channel migration recommendation sub-module is further configured to determine the one or more second financial institution channels based on the one or more second financial institution channels being optimal to both (1) the financial institution based on a lowest financial institution cost per transaction and (2) to the customer based on a most time-efficient channel for conducting the transactions.

In other specific embodiments of the apparatus, the channel migration alert sub-module is further configured to generate and communicate the channel migration recommendation. The recommendation includes at least one of a photograph of the financial institution representative, an audio greeting including a voice recording by the financial institution representative or a video greeting including video footage of the financial institution representative.

A method for targeting channel migration of financial institution transactions conducted by a customer of a financial institution defines second embodiments of the invention. The method includes conducting a financial institution transaction between a customer and a financial institution representative at a first financial institution channel. The method further includes determining, by a computing device processor, one or more second financial institution channels for the customer to conduct other financial institution transactions similar to the financial institution transaction. In addition, the method includes generating and communicating, by a computing device processor, within a selected time after conducting the financial institution transaction, a channel migration recommendation. The recommendation is personalized by the financial institution representative and recommends that the customer conduct future transactions, similar to the financial institution transaction, at the one or more second financial institution channels.

In further embodiments the method includes determining, by a computing device processor, that the customer continuously conducts transactions, similar to the financial transaction, at the first financial institution channel. In such embodiments generating and communicating further include generating and communicating, by a computing device processor, within a selected time after conducting the financial institution transaction and determining that the customer continuously conducts the transactions, a channel migration recommendation.

Moreover, in additional specific embodiments of the method, determining the one or more second financial institution channels further includes determining, by the computing device processor, the one or more second financial institution channels based on the one or more second financial institution channels being optimal to the financial institution based on a lowest financial institution cost per transaction. In other related embodiments of the method, determining the one or more second financial institution channels further includes determining, by the computing device processor, the one or more second financial institution channels based on the one or more second financial institution channels being optimal to the customer based on a most time-efficient channel for conducting the transactions. In still further related embodiments, determining the one or more second financial institution channels further includes determining, by the computing device processor, the one or more second financial institution channels based on the one or more second financial institution channels being optimal to both (1) the financial institution based on a lowest financial institution cost per transaction and (2) the customer based on a most time-efficient channel for conducting the transactions.

In other specific embodiments of the method, generating and communicating the channel migration recommendation further includes generating and communicating, by the computing device process, the channel migration recommendation. The recommendation includes at least one of a photograph of the financial institution representative, an audio greeting including a voice recording by the financial institution representative or a video greeting including video footage of the financial institution representative.

A computer program product including a non-transitory computer-readable medium defines third embodiments of the invention. The computer-readable medium includes instructions for causing a computer to determine one or more second financial institution channels for a customer to conduct future financial institution transactions similar to a financial institution transaction conducted between the customer and a financial institution representative at a first financial institution channel. In addition, the computer-readable medium includes instructions for causing a computer to generate and communicate, within a selected time after conducting the financial institution transaction, a channel migration recommendation. The recommendation is personalized by the financial institution representative and recommends that the customer conduct future transactions, similar to the financial institution transaction, at the one or more second financial institution channels.

Thus, further details are provided below for systems, apparatus, methods and computer program products for targeting financial institution channel migration away from financial institution representative-manned channels, such as banking centers and towards other transaction channels using banking representative-personalized recommendation alerts. In this regard the present invention serves to inform and encourage financial institution customers to use other more optimal financial institution channels for conducting transactions. Once recommendations for alternative transaction channels have been determined, alerts are generated and communicated within a selected time frame after the banking center transaction has been conducted. In addition to the recommendations, the alert is personalized by the banking center representative that assisted the customer, so as to further gain the attention of the customer. Moreover, the alerts may include further information to encourage the customer to use the recommendations, such as directions to the alternative financial institution channels, instructions for using the alternative channels and the like.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is schematic diagram of an apparatus configured to provide targeted financial institution transaction channel migration, in accordance with embodiments of the present invention;

FIG. 2 is another schematic diagram of an apparatus configured to targeted financial institution transaction channel migration, in accordance with embodiments of the present invention;

FIG. 3 is a schematic diagram of a more detailed apparatus configured to provide targeted financial institution transaction channel migration, in accordance with embodiments of the present invention;

FIG. 4 is a flow diagram of a method for providing targeted financial institution transaction channel migration, in accordance with embodiments of the present invention; and

FIG. 5 is another flow diagram of another method for providing targeted financial institution transaction channel migration, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

As may be appreciated by one of skill in the art, the present invention may be embodied as a method, system, computer program product, or a combination of the foregoing. Accordingly, the present invention may take the form of an entirely software embodiment (including firmware, resident software, micro-code, etc.) or an embodiment combining software and hardware aspects that may generally be referred to herein as a “system.” Furthermore, embodiments of the present invention may take the form of a computer program product on a computer-readable medium having computer-usable program code embodied in the medium.

Any suitable computer-readable medium may be utilized. The computer-readable medium may be, for example but not limited to, an electronic, magnetic, optical, electromagnetic, infrared, or semiconductor system, apparatus, device, or propagation medium. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device; or transmission media such as those supporting the Internet or an intranet. Note that the computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of embodiments of the present invention may be written in an object oriented, scripted or unscripted programming language such as Java, Perl, Smalltalk, C++, SAS or the like. However, the computer program code for carrying out operations of embodiments of the present invention may also be written in conventional procedural programming languages, such as the “C” programming language or similar programming languages.

Embodiments of the present invention are described below with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Embodiments of the present invention relate to systems, apparatus, methods, and computer program products for targeting financial institution channel migration based on patterns or trends in a customer's transaction history. Once a trend is identified, for example, a customer makes weekly deposits at a banking center, recommendations for alternative financial channels are determined which are optimal to the financial institution, the customer or both. Optimization is defined in terms of the customer by the recommended transaction channels being more efficient/less time-consuming and in terms of the financial institution the recommended transaction channels being more cost effective. Once the recommended transactions channels are determined, an alert is communicated to the customer in the form of an email, a text message, an online/mobile banking posting or the like, which notifies the customer of the recommended transaction channels. The alert may additionally include further information to entice the customer to use the recommended channels, such as directions to the recommended channels or instructions on how to perform the transaction at the recommended transaction channel.

Additional embodiments of the invention provide for targeting financial institution channel migration based on an interaction/transaction between a customer and a financial institution representative. Within a selected time frame following or concurrent with the banking center transaction, recommendations for alternative financial channels are determined which are optimal to the financial institution, the customer or both. Optimization is defined in terms of the customer by the recommended transaction channels being more efficient/less time-consuming and in terms of the financial institution the recommended transaction channels being more cost effective. Once the recommended transactions channels are determined, an alert is communicated to the customer in the form of an email, a text message, or the like, such that the customer receives the alert while exiting the financial institution or shortly thereafter. The alert is a personalized alert from the financial institution representative that the customer has just transacted with; the personalization may be in the form of text greeting from the representative, a photograph of the representative, and/or an audio or video file including a greeting from the representation. The alert may additionally include further information to entice the customer to use the recommended channels, such as directions to the recommended channels or instructions on how to perform the transaction at the recommended transaction channel.

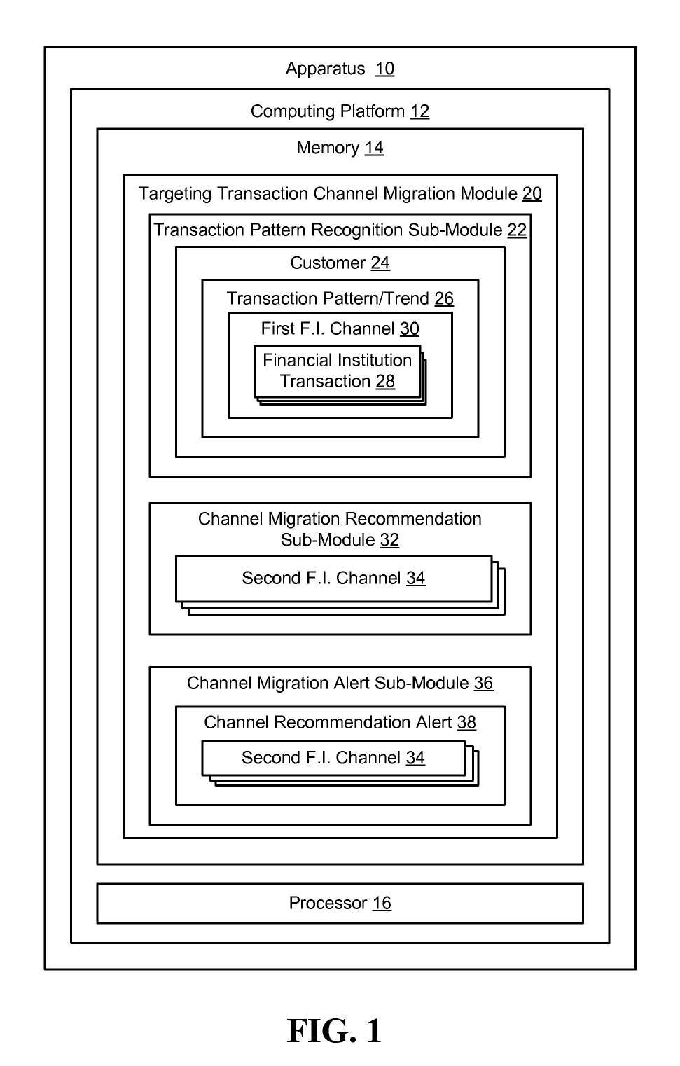

Thus, apparatus, systems, methods and computer program products are herein disclosed that provide for targeting financial institution channel migration. FIG. 1 provides a high level schematic diagram of an apparatus 10 configured for targeting financial institution channel migration based on patterns/trends identified in a customer's transaction history, in accordance with embodiments of the present invention.

The apparatus 10 includes a computing platform 12 having at least one processor 16 and a memory 14. The memory 14 of apparatus 10 stores targeting transaction channel migration module 20 that is configured to target financial institution transaction channels for migration based on a customer's transaction patterns/trends, in accordance with embodiments of the present invention. Transactions channels may include any physical location, device or electronic network interface at which a customer may conduct a financial institution related transaction, such as a deposit, withdrawal, account transfer, payment, account inquiry or the like. For example financial institution transaction channels may include, but are not limited to, banking centers, Automated Teller Machines (ATMs), call centers, online banking, mobile banking, Person-To-Person (P2P), and the like.

Targeting transaction channel migration module 20 includes transaction pattern recognition sub-module 22 that is configured to access one or more transaction history databases (not shown in FIG. 1) to determine or otherwise recognize transaction patterns 26, otherwise referred to herein as trends, associated with a customer 24 based on the customer's transaction history. The transaction history databases may be monitored continuously, such that patterns or trends are determined within a selected time frame (i.e., proximate in time to completion of a pattern identifying transaction) or the transaction databases may be accessed or a periodic basis, scheduled or otherwise, to determine transaction patterns or trends.

A transaction pattern 26 is defined by a customer 24 conducting financial institution transactions 28 at a transaction channel, first transaction channel 30 of FIG. 1, on a continual basis. The continual basis may be defined as two or more occurrence of a transaction 28 at the transaction channel 30. The number of occurrences of a transaction 28 at which a transaction pattern 26 is recognized may be configured by the financial institution. Further, the transaction channel 30 in the determined transaction pattern 26 may be a specific transaction channel, such as specific banking center location or a specific ATM, or the transaction channel may be general to a transaction channel type, e.g., banking centers, ATMs, online/mobile banking and the like. As discussed infra. recognized patterns or trends may further identify a specific party associated with the transaction (e.g., customer transfers money to “X”), a specific time of the week, month, year in which the customer performs the transactions, a specific time of day for the transactions, the approximate amount of the transactions, the geographic location of the transaction or the like. Such further attributes of the recognized transaction pattern may subsequently be used to determine which alternative transaction channel is best suited or most optimal to recommend to the customer.

Additionally, targeting transaction channel migration module 20 includes channel migration recommendation sub-module 32 that is configured to determine one or more alternative transaction channels, second transaction channel(s) 34 of FIG. 1, to recommend to the customer for conducting future transactions similar to the transactions in the recognized pattern or trend. The second transaction channel(s) 34 are determined based on the channel being optimal to at least one of the financial institution or the customer. In this regard, optimal in terms of the financial institution may be defined as the least costly (costs incurred by financial institution) channel for the customer to conduct the transactions. While optimal in terms of the customer may be defined as the most time efficient (e.g., closest in proximity to residence or place of business) or least costly (e.g., least amount of transportation costs incurred). In specific embodiments the recommendation sub-module 32 may be configured determine the second transaction channels based on the channel(s) being optimal to both the financial institution and the customer. If the interests of the financial institution and the customer are in conflict in terms of optimization (e.g., a channel is the least costly to the financial institution but not time efficient for the customer), weighting factors may be employed or some mechanism to determine which transaction channels should be recommended.

In addition, targeting transaction channel migration module 20 includes channel migration alert sub-module 36 which is configured to generate and initiate communication of channel recommendation alert 38 to the customer that is configured to recommend that the customer 24 conduct future transactions associated with the transaction pattern 26 at the second transaction channel(s) 34. In the event that one of recommended channels is an electronic channel, the recommendation alert 38 may include a link to the channel being recommended, such as a link to an online banking site or the like. The channel recommendation alert 38 may be configured by the financial institution or the customer to be communicated through a communication channel of choice, such as electronic email (i.e., email), Short Message Service (SMS)/text message, posting at the customer's online/mobile banking account site or the like. In addition, the customer may be provided a user interface, such as a web-based interface implementing through an online banking website or a mobile banking application, at which the customer may define thresholds for sending the alerts 38 (e.g., define what constitutes a pattern) and/or the frequency for sending such alerts.

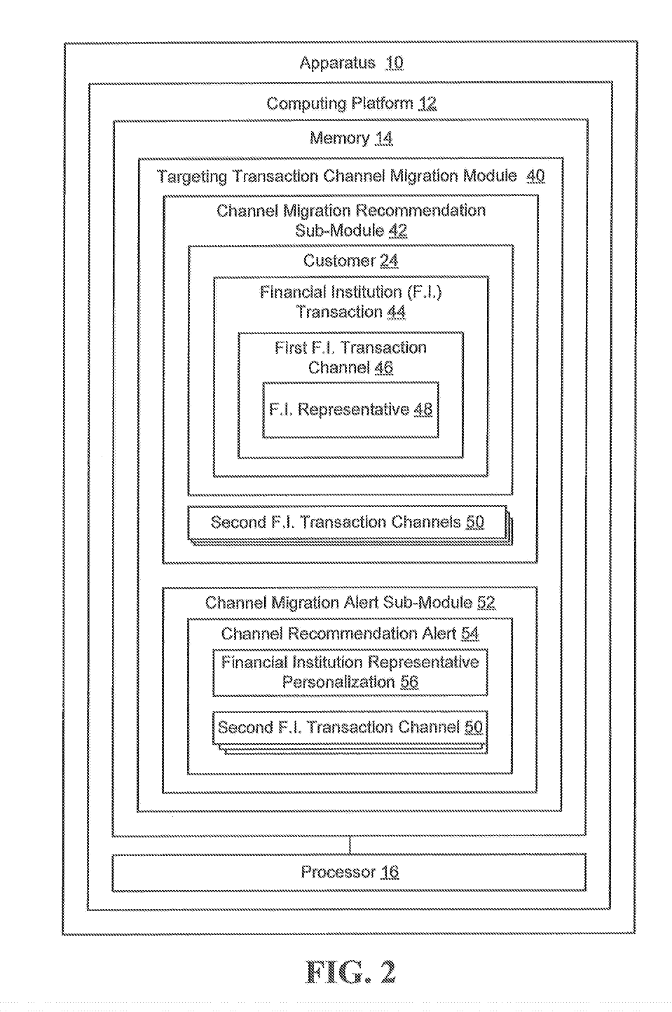

FIG. 2 provides a high level schematic diagram of an apparatus 10 configured for targeting financial institution channel migration based on a just completed transaction at financial institution representative-based channel, including financial representative-personalized recommendation alerts, in accordance with embodiments of the present invention.

Similar to FIG. 1, the apparatus 10 includes a computing platform 12 having at least one processor 16 and a memory 14. The memory 14 of apparatus 10 stores targeting transaction channel migration module 40 configured to target financial institution transaction channels for migration based on a customer conducting a financial transaction at a banking center, in accordance with embodiments of the present invention. Banking center transactions are typically high cost to the financial institution, in that they require financial institution representatives to assist the customer in conducting the transaction, such as a deposit, withdrawal, account transfer, payment, account inquiry or the like.

Targeting transaction channel migration module 40 includes channel migration recommendation sub-module 42 that is configured to determine one or more alternative transaction channels 50 of FIG. 1, to recommend to the customer 24 based on the customer having just completed a financial institution transaction 44 at a first financial institution channel 46 (e.g., banking center, call center, chat session within online banking or mobile banking application or the like). The recommended alternative transaction channels 50 are recommended for transactions that are the same or similar to the just completed transaction at the first financial institution channel. The channel migration recommendation sub-module 42 may be configured to execute automatically based on the completion of the transaction 44 at the first financial institution channel 46 or the module 42 may be configured to execute at the bequest of the financial institution representative (i.e., banking associate) that assisted the customer 24 with the transaction 44. The alternative transactions channels 50 may include any physical location, device or electronic network interface at which a customer may conduct a financial institution-related transaction, such as a deposit, withdrawal, account transfer, payment, account inquiry or the like. For example financial institution transaction channels may include, but are not limited to, Automated Teller Machines (ATMs), call centers, online banking, mobile banking, Person-To-Person (P2P), and the like.

In specific embodiments of the apparatus, the channel migration recommendation sub-module 42 is configured to determine the alternative transaction channel(s) 50 based on the channel being optimal to at least one of the financial institution or the customer. In this regard, optimal in terms of the financial institution may be defined as the least costly (costs incurred by financial institution) channel for the customer to conduct the transactions. In addition, optimal in terms of the customer may be defined as the most time efficient (e.g., closest in proximity to residence or place of business) or least costly (e.g., least amount of transportation costs incurred). In specific embodiments the recommendation sub-module 42 may be configured determine the alternative transaction channels 50 based on the channel(s) being optimal to both the financial institution and the customer. If the interests of the financial institution and the customer are in conflict in terms of optimization (e.g., a channel is the least costly to the financial institution but not time efficient for the customer), weighting factors may be employed or some mechanism to determine which transaction channels should be recommended.

In addition, targeting transaction channel migration module 40 includes channel migration alert sub-module 52 which is configured to generate and initiate immediate communication (after completion of the transaction at the banking center) of a channel recommendation alert 54 to the customer. The channel recommendation alert 54 is configured to recommend that the customer conduct future transactions, similar to the financial transaction just completed at the banking center, at one or more of the alternative transaction channels 50. In the event that one of recommended channels is an electronic channel, the recommendation alert 54 may include a link to the channel being recommended, such as a link to an online banking site or the like.

In addition, the channel recommendation alert 54 is defined as being personalized by the financial institution representative that assisted the customer in conducting the transaction at the first financial institution channel. The personalization may be in the form of a textural greeting, an image of the representative and/or an audio/video clip of the representative. Further in specific embodiments the personalization may be automatically generated by the sub-module or, in other embodiments, the personalization may be inputted (or the automated personalization augmented) by the representative after completion of the transaction.

The channel recommendation alert 38 may be configured by the financial institution or the customer to be communicated through a communication channel of choice, such as electronic email (i.e., email), Short Message Service (SMS)/text message, posting at the customer's online/mobile banking account site or the like. In addition, the customer may be provided a user interface, such as a web-based interface implementing through an online banking website or a mobile banking application, at which the customer may define thresholds for sending the alerts 38 (e.g., define what constitutes a pattern) and/or the frequency for sending such alerts.

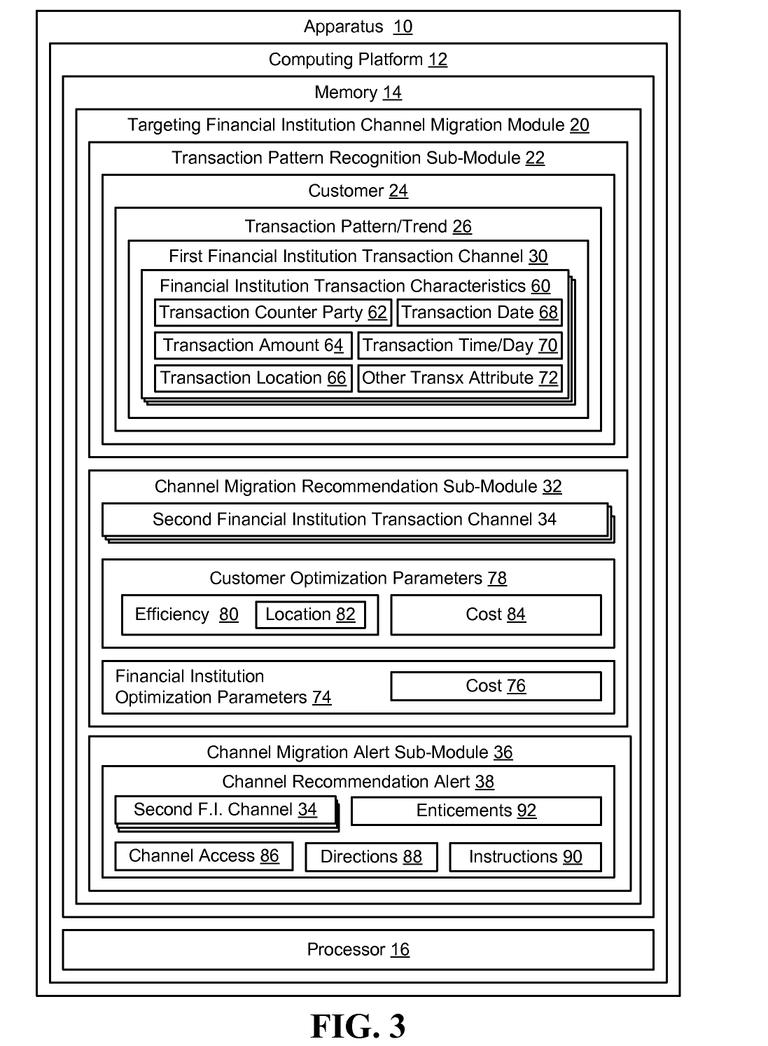

Referring to FIG. 3, shown is a more detailed block diagram of apparatus 10, according to embodiments of the present invention. The apparatus 10 is configured to provide for targeting financial institution channel migration. In addition to providing greater detail, FIG. 3 highlights various alternate embodiments of the invention. The apparatus 10 may include one or more of any type of computing device. The present apparatus and methods can accordingly be performed on any form of one or more computing devices.

The apparatus 10 includes computing platform 12 that can receive and execute algorithms, such as routines, and applications. Computing platform 12 includes memory 14, which may comprise volatile and non-volatile memory, such as read-only and/or random-access memory (RAM and ROM), EPROM, EEPROM, flash cards, or any memory common to computer platforms. Further, memory 14 may include one or more flash memory cells, or may be any secondary or tertiary storage device, such as magnetic media, optical media, tape, or soft or hard disk.

Further, computing platform 12 also includes processor 16, which may be an application-specific integrated circuit (“ASIC”), or other chipset, processor, logic circuit, or other data processing device. Processor 16 or other processor such as ASIC may execute an application programming interface (“API”) (not shown in FIG. 3) that interfaces with any resident programs, such as targeting transaction channel migration module 20 (or 40 of FIG. 2) and algorithms associated therewith or the like stored in the memory 14 of the apparatus 10.

Processor 16 includes various processing subsystems embodied in hardware, firmware, software, and combinations thereof, that enable the functionality of apparatus 10 and the operability of the apparatus on a network. For example, processing subsystems allow for initiating and maintaining communications and exchanging data with other networked devices. For the disclosed aspects, processing subsystems 50 of processor 14 may include any subsystem used in conjunction with targeting transaction channel migration module 20 and related algorithms, sub-algorithms, sub-modules thereof.

Computer platform 12 may additionally include communications module (not shown in FIG. 3) embodied in hardware, firmware, software, and combinations thereof, that enables communications among the various components of the apparatus 10, as well as between the other networked devices. Thus, communication module may include the requisite hardware, firmware, software and/or combinations thereof for establishing a network communication connection and communicating channel recommendation alerts 38 or reports including scan results to designated entities.

As previously noted, the memory 14 of apparatus 10 stores targeting transaction channel migration module 20 that is configured target financial institution transaction channels for migration based on a customer's transaction patterns/trends, in accordance with embodiments of the present invention.

Targeting transaction channel migration module 20 includes transaction pattern recognition sub-module 22 that is configured to access one or more transaction history databases (not shown in FIG. 3) to determine or otherwise recognize transaction patterns 26, otherwise referred to herein as trends, associated with a customer 24 based on the customer's transaction history.

A transaction pattern 26 is defined by a customer 24 conducting financial institution transactions 28 at a transaction channel, first transaction channel 30, on a continual basis. The continual basis may be defined as two or more occurrence of a transaction 28 at the transaction channel 30. The number of occurrences of a transaction 28 at which a transaction pattern 26 is recognized may be configured by the financial institution. Further, the transaction channel 30 in the determined transaction pattern 26 may be a specific transaction channel, such as specific banking center location or a specific ATM, or the transaction channel may be general to a transaction channel type, e.g., banking centers, ATMs, online/mobile banking and the like.

Recognized patterns or trends may further identify other financial institution transaction characteristics 60 and such characteristics may be used as further determining factors in which channels should be recommended to the customer 24. (i.e., which alternative channel is best suited or most optimal to recommend to the customer). The transaction characteristics may include transaction counter party 62 (e.g., the payee or depositee accepted the customer's payment or deposit), transaction amount 64, transaction location 66, transaction date 68, transaction time/day 70 and any other transaction attribute 72. Examples of how the transaction characteristics 50 may be used to determine the recommended second channels 34 are provided infra.

Targeting transaction channel migration module 20 includes channel migration recommendation sub-module 32 that is configured to determine one or more alternative transaction channels, second transaction channel(s) 34, to recommend to the customer for conducting future transactions similar to the transactions 28 in the recognized pattern/trend 26. The second transaction channel(s) 34 are determined based on the channel being optimal to at least one of the financial institution or the customer. In this regard, financial institution optimization parameters 74 may be defined as cost 76, with the least costly channel (costs incurred by financial institution) being the most optimal. While customer optimization parameters 78 may be defined as efficiency 80, with the channel requiring the least amount of the customer's time being most optimal. Included within the efficiency parameter 80 is the location 82 parameter, with the channel closest on location to a customer's residence, normal commute pattern or place of business being most optimal. Additionally, customer optimization parameters 78 may include cost 84 of conducting the transaction (e.g., transportation costs, network/communication costs and the like), with the least costly channel being the most optimal. In specific embodiments the recommendation sub-module 32 may be configured determine the second transaction channels based on the channel(s) being optimal to both the financial institution and the customer. If the interests of the financial institution and the customer are in conflict in terms of optimization (e.g., a channel is the least costly to the financial institution but not time efficient for the customer), weighting factors may be employed or some mechanism to determine which transaction channels should be recommended.

Further, as described above the channel migration recommendation sub-module 32 may rely on other transaction characteristics 60 in the pattern/trend 26 in determining which second transaction channels 34 to recommend to the customer 24. For example if the determined pattern/trend 26 indicates that the customer conducts transaction at a specific ATM every Monday morning at approximately the same time. The recommendation logic can compare the ATM location to the customer's residence address, place of business address and normal commute pattern and time (derived from transaction data over time) to determine if the ATM is most convenient ATM for the customer to use. If it is determined that the ATM is the most convenient for the customer, other channel types may be recommended to the customer if they apply to the transaction being made. For example, if the ATM transaction is an account transfer, the recommended second channels may be mobile or online banking or the like. If it is determined that the ATM is not the most conveniently located for the customer, the second transaction channels recommended to the customer may include the more convenient or the most convenient ATM(s). If the transaction is a cash withdrawal transaction, ATMs may be the only channels recommended, however, if the transactions in the pattern include account transfers or deposits other forms of channels in addition to or in lieu of ATMs may also be recommended.

In another example, if the transactions 28 in the determined transaction pattern/trend 26 are all conducted with a specific counter party 62, for example, payments to a specific individual, the recommendation logic may be configured to determine the payment types accepted by the individual and make recommendations for second transaction channels based on the payment types accepted. For example, if the individual is determined to have the capability to accept person-to-person payments (P2P), the recommendation provided to the customer 24 may include the P2P transaction channel.

In addition, targeting transaction channel migration module 20 includes channel migration alert sub-module 36 which is configured to generate and initiate communication of channel recommendation alert 38 to the customer that is configured to recommend that the customer 24 conduct future transactions associated with the transaction pattern 26 at the second transaction channel(s) 34. In the event that one of recommended channels is an electronic channel, the recommendation alert 38 may include provide immediate channel access 86 to the channel being recommended in the form of a link or the like, such as a link to an online banking site, a link that launches a mobile banking application or the like.

In addition, the channel recommendation alert 38 may include other information beneficial to inducing the customer to migrate to the recommended second channels 34. Such information may include directions 88 to the second channels, if the channels are associated with a physical location, such as a specific ATM, banking center or the like. The directions, including maps or the like, may be embedded in the alert or the alert may include provide for network-accessible directions via link provided in the alert.

Additionally, the channel recommendation alert 38 may include instructions 90 for performing the transaction at the second channel 34. The instructions may be embedded in the alert or the alert may include provide for network-accessible instructions via link provided in the alert. The link may provide network access to audio or video presentations that instruct the customer in how to use the channel to conduct the transaction. Additionally, the alert may recognize the customer's familiarity with a recommended channel and provide instructions equivalent to the level of understanding of the channel. For example, if the second channel is one that the customer does not typically use (as indicated by the customer's transaction history), for example, online or mobile banking, the instructions provide may be more detailed than if the customer regularly uses that particular channel.

Moreover, the channel recommendation alert 38 may include enticements 92 for the customer to use the recommended channel. The enticement 92 may be a reward or the like that serves to encourage the customer to migrate towards the recommended the channel.

The channel recommendation alert 38 may be configured by the financial institution or the customer to be communicated through a communication channel of choice, such as electronic email (i.e., email), Short Message Service (SMS)/text message, posting at the customer's online/mobile banking account site or the like. In addition, the customer may be provided a user interface, such as a web-based interface implementing through an online banking website or a mobile banking application, at which the customer may define thresholds for sending the alerts 38 (e.g., define what constitutes a pattern) and/or the frequency for sending such alerts.

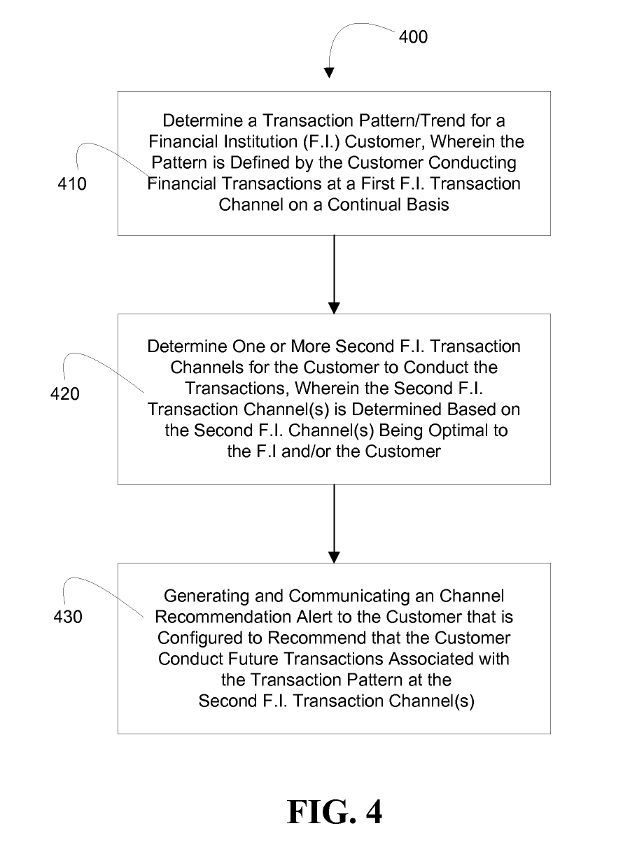

Referring to FIG. 4, a flow diagram is presented of a method 400 for targeting transaction channel migration of financial institution transactions conducted by a customer, in accordance with embodiments of the present invention. At Event 410, a transaction pattern, otherwise referred to as a transaction trend, is determined for the customer. The transaction pattern is defined by the customer conducting financial institution transactions at a first transaction channel on a continual basis. The financial institution and/or the customer may define what constitutes continual basis so as to dictate when channel recommendation alerts are forthcoming. At a minimum, two or more transactions at a channel may constitute a transaction pattern. The first transaction channel may be a specific channel, such as a specific ATM or banking center or the first transaction channel may a type of channel, such as ATMs, banking centers, online banking, mobile banking, call center or the like. In addition to identifying the first channel, other attributes related to the transaction pattern may also be identified, such as transaction counter party, transaction amount, transaction location, transaction date, transaction time/day, and the like. The other transaction attributes identified in the transaction pattern may be used to further determine which channels to recommend to the customer for future similar transactions.

At Event 420, one or more second transaction channels are determined for recommending to the customer that they conduct future transactions that are the same or similar to transactions in the transaction pattern. The second transaction channel(s) are determined based on the channel(s) being optimal to one or both of the financial institution and/or the customer. In terms of the financial institution, optimal may be defined based on a cost of the transactions, such that the lowest cost incurred by the financial institution in conducting the transaction is most optimal. In terms of the customer, optimal may be defined based on time efficiency, such that the least time consuming channel is most optimal to the customer. Alternatively, optimal may be defined based on the physical location of the channel, such that the channel(s) closest in proximity to the customer's residence, place of business or commute pattern are the most optimal to the customer. In addition, optimal may be defined based on the cost incurred by the customer, for example, transportation costs, network costs or the like, such that the lowest cost channel is the most optimal. In specific embodiments, recommended transaction channel(s) take into account both customer and financial institution optimization. In such embodiments if the interests of the financial institution and the customer conflict (i.e., different recommendations result), the customer interests may prevail or be dominant in the decision/recommendation process.

At Event 430, a transaction channel recommendation alert is generated and communication of the alert to the customer is initiated. The alert is configured to recommend that the customer conduct future transactions, associated with the transaction pattern, at the second transaction channel(s). The alert may be sent by the customer's designated communication channel of choice; such as email, SMS/text message, online or mobile banking posting or the like. In addition, to the recommendation, the alert may include access to the channel, such as a link to an online banking site or a link that launches a mobile banking application. Moreover, in the event that the recommended channels include physically located channels, the alert may include directions or network-access to directions to the channel. In addition, the alert may include instructions or access to instructions, such as audio/video instructions, on how to implement the recommended channel to conduct the transaction. The instructions may be generic to the channel or, in other embodiments the instructions may be specific to the transaction type in the transaction pattern.

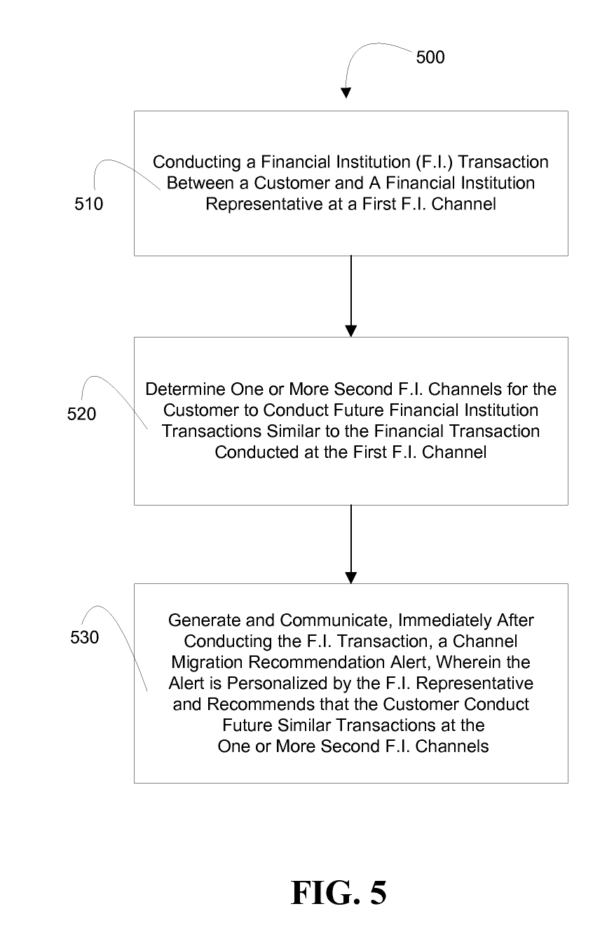

Referring to FIG. 5, a flow diagram is presented of a method 500 for targeting transaction channel migration of financial institution transactions conducted by a customer, in accordance with embodiments of the present invention. At Event 510, a financial institution transaction is conducted between a customer and a financial institution representative at first financial institution channel, for example a banking center, call center, online banking website, mobile banking application or the like. The transaction may be any transaction normally conducted at a banking center, such as, but not limited to, a deposit, a withdrawal, a payment, an account inquiry or the like.

At Event 520, one or more alternative second financial institution channels (other than the first financial institution channel) are determined for the customer. The alternative second financial institution channels are to be recommended to the customer as options for conducting similar transactions to the just completed financial transaction conducted at the first financial institution channel. In specific embodiments of the method, the alternative transaction channel(s) are determined based on the channel(s) being optimal to one or both of the financial institution and/or the customer. In terms of the financial institution, optimal may be defined based on a cost of the transactions, such that the lowest cost incurred by the financial institution in conducting the transaction is most optimal. In terms of the customer, optimal may be defined based on time efficiency, such that the least time consuming channel is most optimal to the customer. Alternatively, optimal may be defined based on the physical location of the channel, such that the channel(s) closest in proximity to the customer's residence, place of business or commute pattern are the most optimal to the customer. In addition, optimal may be defined based on the cost incurred by the customer, for example, transportation costs, network costs or the like, such that the lowest cost channel is the most optimal. In specific embodiments, recommended transaction channel(s) take into account both customer and financial institution optimization. In such embodiments if the interests of the financial institution and the customer conflict (i.e., different recommendations result), the customer interests may prevail or be dominant in the decision/recommendation process.

At Event 530, a transaction channel recommendation alert is generated and communication of the alert to the customer is initiated within a selected time frame after conducting the financial institution transaction at the banking center. Such immediate communication insures that the customer can receive the alert, via a mobile device, shortly after completing the transaction (e.g., while still in or departing the banking center). The alert is configured to recommend that the customer conduct future transactions, similar to the just completed transaction at the banking center, at the second transaction channel(s).

In addition, the alert is personalized by the financial institution representative that assisted the customer in conducting the transaction at the banking center. The personalization may come in the form of a textural greeting for the representative, a photographic image of the representative, an audio/video presentation by the representative or the like. The personalization may be automatically generated after completion of the transaction at the banking center or the personalization may be inputted by the representative after completion of the transaction.

The alert may be sent by the customer's designated communication channel of choice; such as email, SMS/text message, online or mobile banking posting or the like. In addition, to the recommendation, the alert may include access to the channel, such as a link to an online banking site or a link that launches a mobile banking application. Moreover, in the event that the recommended channels include physically located channels, the alert may include directions or network-access to directions to the channel. In addition, the alert may include instructions or access to instructions, such as audio/video instructions, on how to implement the recommended channel to conduct the transaction. The instructions may be generic to the channel or, in other embodiments the instructions may be specific to the transaction type in the transaction pattern.

Thus, present embodiments herein disclosed provide for targeting financial institution channel migration away from financial institution representative-based channels, such as banking centers and towards other transaction channels using banking representative-personalized recommendation alerts. In this regard the present invention serves to inform and encourage financial institution customers to use other more optimal financial institution channels for conducting transactions. Once recommendations for alternative transaction channels have been determined, alerts are generated and communicated within a selected time frame after the banking center transaction has been conducted. In addition to the recommendations, the alert is personalized by the banking center representative that assisted the customer, so as to further gain the attention of the customer. Moreover, the alerts may include further information to encourage the customer to use the recommendations, such as directions to the alternative financial institution channels, instructions for using the alternative channels and the like.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other updates, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

1. An apparatus for targeting channel migration of financial institution transactions conducted by a customer of a financial institution, the apparatus comprising:
a computing platform including a memory and at least one processor;
a targeting channel migration module stored in the memory, executable by the processor and including:
a channel migration recommendation sub-module configured to determine one or more second financial institution channels to recommend to a customer to conduct future financial institution transactions that are similar to a financial institution transaction currently being conducted between the customer and a financial institution representative at a first financial institution channel, wherein the first financial institution channel is one of a banking center, a call center or a chat session within an online or mobile banking application and wherein the second financial institution channels are determined based on at least one of (1) the one or more second financial institution channels being less costly to the financial institution for conducting the similar financial transactions and (2) the one or more second financial institution channels being less time consuming for the customer to conduct the similar financial transactions; and
a channel migration alert sub-module configured to generate and communicate to the customer, immediately after completing the financial institution transaction, a channel migration recommendation alert, wherein the recommendation alert includes personalization from the financial institution representative and recommends that the customer conduct future transactions, similar to the financial institution transaction, at the one or more second financial institution channels, wherein the personalization comprises at least one of (a) a text greeting from the financial institution representative, (b) a photographic image of the financial institution representative or (c) an audio or video presentation by the financial institution representative.

2. The apparatus of claim 1, wherein the targeting channel migration module further comprises a transaction pattern recognition sub-module configured to determine that the customer continuously conducts transactions, similar to the financial transaction, at the first financial institution channel.

3. (canceled)

4. (canceled)

5. The apparatus of claim 1, wherein the channel migration recommendation sub-module is further configured to determine the one or more second financial institution channels based on the one or more second financial institution channels being both (1) less costly to the financial institution for conducting the similar financial transactions and (2) less time consuming for the customer to conduct the similar financial transactions.

6. (canceled)

7. (canceled)

8. A method for targeting channel migration of financial institution transactions conducted by a customer of a financial institution, the method comprising:
conducting a financial institution transaction between a customer and a financial institution representative at a first financial institution channel wherein the first financial institution channel is one of a banking center, a call center or a chat session within an online or mobile banking application;
determining, by a computing device processor, one or more second financial institution channels to recommend to the customer to conduct other financial institution transactions that are similar to the financial institution transaction, wherein the second financial institution channels are determined based on at least one of (1) the one or more second financial institution channels being less costly to the financial institution for conducting the similar financial transactions and (2) the one or more second financial institution channels being less time consuming for the customer to conduct the similar financial transactions; and
generating and communicating, by a computing device processor, immediately after completing the financial institution transaction, a channel migration recommendation alert, wherein the recommendation alert includes personalization from the financial institution representative and recommends that the customer conduct future transactions, similar to the financial institution transaction, at the one or more second financial institution channels, wherein the personalization comprises at least one of (a) a text greeting from the financial institution representative, (b) a photographic image of the financial institution representative or (c) an audio or video presentation by the financial institution representative.

9. The method of claim 8, further comprising determining, by a computing device processor, that the customer continuously conducts transactions, similar to the financial transaction, at the first financial institution channel.

10. (canceled)

11. (canceled)

12. The method of claim 8, wherein determining the one or more second financial institution channels further comprises determining, by the computing device processor, the one or more second financial institution channels based on the one or more second financial institution channels being both (1) less costly to the financial institution for conducting the similar financial transactions and (2) less time consuming for the customer to conduct the similar financial transactions.

13. (canceled)

14. The method of claim 8, wherein generating and communicating the channel migration recommendation occurs either automatically, in response to the customer completing the financial institution transaction, or at the bequest of the financial institution representative.

15. A computer program product comprising:
a non-transitory computer-readable medium comprising:
instructions for causing a computer to determine one or more second financial institution channels to recommend to a customer to conduct future financial institution transactions similar to a currently being financial institution transaction conducted between the customer and a financial institution representative at a first financial institution channel, wherein the first financial institution channel is one of a banking center, a call center or a chat session within an online or mobile banking application and wherein the second financial institution channels are determined based on at least one of (1) the one or more second financial institution channels being less costly to the financial institution for conducting the similar financial transactions and (2) the one or more second financial institution channels being less time consuming for the customer to conduct the similar financial transactions; and
instructions for causing a computer to generate and communicate to the customer, immediately after completing the financial institution transaction, a channel migration recommendation, wherein the recommendation alert includes personalization from the financial institution representative and recommends that the customer conduct future transactions, similar to the financial institution transaction, at the one or more second financial institution channels, wherein the personalization comprises at least one of (a) a text greeting from the financial institution representative, (b) a photographic image of the financial institution representative or (c) an audio or video presentation by the financial institution representative.

16. The computer program product of claim 15, further comprising instructions for causing a computer to determine that the customer continuously conducts transactions, similar to the financial transaction, at the first financial institution channel.

17. (canceled)

18. (canceled)

19. The computer program product of claim 15, wherein the instructions for causing the computer to determine the one or more second financial institution channels further comprises instructions for causing the computer to determine the one or more second financial institution channels based on the one or more second financial institution channels being both (1) less costly to the financial institution for conducting the similar financial transactions and (2) less time consuming for the customer to conduct the similar financial transactions.

20. (canceled)
